(19) United States
(12) Patent Application Publication
(10) Pub. No.: US 2019/0302497 A1
(43) Pub. Date: Oct. 3, 2019

(54) WAVELENGTH CONVERSION FILM AND METHOD OF MANUFACTURING WAVELENGTH CONVERSION FILM

(71) Applicant: FUJIFILM Corporation, Tokyo (JP)

(72) Inventors: Satoshi KUNIYASU, Kanagawa (JP); Tatsuya OBA, Kanagawa (JP)

(73) Assignee: FUJIFILM Corporation, Tokyo (JP)

(21) Appl. No.: 16/444,470

(22) Filed: Jun. 18, 2019

Related U.S. Application Data
(63) Continuation of application No. PCT/JP2017/044338, filed on Dec. 11, 2017.

(30) Foreign Application Priority Data
Dec. 19, 2016 (JP) 2016-245433

(51) Int. Cl. G02F 1/13357

(52) U.S. Cl. CPC G02F 1/1336; G02F 2001/133614

(57) ABSTRACT

An object is to provide: a wavelength conversion film in which deterioration of wavelength conversion particles caused by oxygen can be prevented and optical characteristics are also excellent; and a method of manufacturing the wavelength conversion film. The object is achieved with the wavelength conversion film including: a wavelength conversion layer; and a substrate that supports the wavelength conversion layer, in which the wavelength conversion layer includes a polyvinyl alcohol having a saponification degree in a range of 86 to 97 mol % and cured product particles of a (meth)acrylate compound including wavelength conversion particles.

### CROSS-REFERENCE TO RELATED APPLICATIONS

This application is a Continuation of PCT International Application No. PCT/JP2017/044338 filed on Dec. 11, 2017, which claims priority under 35 U.S.C. § 119(a) to Japanese Patent Application No. 2016-245433 filed on Dec. 19, 2016. The above application is hereby expressly incorporated by reference, in its entirety, into the present application.

### BACKGROUND OF THE INVENTION

### 1. Field of the Invention

The present invention relates to a wavelength conversion film and a method of manufacturing the wavelength conversion film.

### 2. Description of the Related Art

A liquid crystal display device has been more widely used as a space-saving image display device having low power consumption. In addition, recently, in order to improve the performance of a liquid crystal display device, a further reduction in power consumption, improvement of color reproducibility, and the like are required.

Along with a reduction in the power consumption of a backlight of a liquid crystal display device, the use of a wavelength conversion film that converts the wavelength of incidence light is known in order to increase the light use efficiency and to improve the color reproducibility. In addition, as the wavelength conversion film, a wavelength conversion film using quantum dots is known.

The quantum dot is a crystal having an electronic state in which all the three-dimensional moving directions are restricted. In a case where a nanoparticle of a semiconductor is three-dimensionally surrounded by a high potential barrier, this nanoparticle is a quantum dot. The quantum dot exhibits various quantum effects. For example, “quantum size effect” of making of the density of electronic states (energy level) discrete is exhibited. According to this quantum size effect, the absorption wavelength and emission wavelength of light can be controlled by changing the size of quantum dots.

For example, a wavelength conversion film using quantum dots has a configuration in which a wavelength conversion layer (quantum dot layer) in which quantum dots are dispersed in a binder formed of a resin or the like is sandwiched between substrates such as a resin film.

Here, quantum dots are likely to deteriorate due to oxygen and have a problem in that the emission intensity decreases due to a photooxidation reaction. As a method of solving this problem, a method of using a gas barrier film having high gas barrier properties (oxygen barrier properties) for a substrate can be considered. However, the gas barrier film having high gas barrier properties is expensive. Further, the configuration in which the wavelength conversion layer is sandwiched between the resin films or the like cannot prevent deterioration of quantum dots caused by infiltration of oxygen from an end surface of a wavelength conversion layer.

On the other hand, a wavelength conversion film including a wavelength conversion layer in which microparticles including quantum dots are dispersed in a binder is also known.

For example, JP5744033B describes a configuration in which a coating including a resin having low oxygen permeability such as polyvinyl alcohol is provided over outer surfaces of microparticles (coated particles) including quantum dots (particles having light emitting properties) that are dispersed in a host material. JP5744033B describes a wavelength conversion film in which a wavelength conversion layer is formed using a coating composition that is prepared by dispersing the microparticles in the coating.

### SUMMARY OF THE INVENTION

The quantum dot nanoparticles described in JP5744033B are coated with the resin having a low oxygen permeability such as polyvinyl alcohol to form the microparticles.

Therefore, deterioration of the quantum dots caused by gas can be prevented.

However, in a case where a wavelength conversion film is prepared using the quantum dot nanoparticles described in JP5744033B, deterioration of the quantum dot nanoparticles caused by oxygen can be prevented, but the microparticles are likely to aggregate. It was found that, in a case where the microparticles aggregate, point defects, insufficient flatness of a coating film, or the like occurs, which causes surface defects unique to the film.

That is, in the wavelength conversion film, excellent dispersibility of the microparticles is required in order to exhibit excellent optical characteristics such as high-luminance emission or high-uniformity light irradiation without color unevenness.

An object of the present invention is to solve the above-described problem of the related art and to provide: a wavelength conversion film in which deterioration of wavelength conversion particles such as quantum dots caused by oxygen can be prevented and optical characteristics are also excellent; and a preferable method of manufacturing the wavelength conversion film.

In order to achieve the object, according to a first aspect of the present invention, there is provided a wavelength conversion film comprising: a wavelength conversion layer; and a substrate that supports the wavelength conversion layer, in which the wavelength conversion layer includes a polyvinyl alcohol having a saponification degree in a range of 86 to 97 mol % and cured product particles of a (meth)acrylate compound including wavelength conversion particles.

In the first aspect of the wavelength conversion film according to the present invention, it is preferable that the polyvinyl alcohol is a modified polyvinyl alcohol.

In addition, it is preferable that an average particle size of the cured product particles of the (meth)acrylate compound is 0.5 to 5 μm.

In addition, according to a second aspect of the present invention, there is provided a wavelength conversion film comprising: a wavelength conversion layer; and a substrate that supports the wavelength conversion layer,

in which the wavelength conversion layer includes a copolymer of butene diol and vinyl alcohol and cured product particles of a (meth)acrylate compound including wavelength conversion particles.

In the second aspect of the wavelength conversion film according to the present invention, it is preferable that an average particle size of the cured product particles of the (meth)acrylate compound is 0.5 to 5 μm.

Further, according to the present invention, there is provided a method of manufacturing a wavelength conversion film comprising:

a step of preparing a dispersion in which wavelength conversion particles are dispersed in a liquid (meth)acrylate compound;

a step of preparing an emulsion by putting the dispersion into an aqueous solution of a water-soluble polymer;

a step of preparing a coating solution by irradiating the emulsion with light to cure the (meth)acrylate compound; and

a step of applying the coating solution to a substrate and drying the coating solution.

In the method of manufacturing a wavelength conversion film according to the present invention, it is preferable that the water-soluble polymer is a polyvinyl alcohol having a saponification degree in a range of 86 to 97 mol %.

In addition, it is preferable that the water-soluble polymer is a copolymer of butene diol and vinyl alcohol.

According to the present invention, it is possible to provide: a wavelength conversion film in which deterioration of wavelength conversion particles caused by oxygen can be prevented and optical characteristics are also excellent; and a preferable method of manufacturing the wavelength conversion film.

### BRIEF DESCRIPTION OF THE DRAWINGS

FIG. 1 is a diagram conceptually illustrating an example of a planar lighting device including an example of a wavelength conversion film according to the present invention.

FIG. 2 is a diagram conceptually illustrating an example of the wavelength conversion film according to the present invention.

### DESCRIPTION OF THE PREFERRED EMBODIMENTS

Hereinafter, a wavelength conversion film according to the present invention a method of manufacturing the wavelength conversion film will be described in detail based on a preferable embodiment illustrated in the accompanying drawings.

The following description regarding components has been made based on a representative embodiment of the present invention. However, the present invention is not limited to the embodiment.

In this specification, numerical ranges represented by “to” include numerical values before and after “to” as lower limit values and upper limit values.

In addition, in this specification, “(meth)acrylate” represents at least one or any one of acrylate or methacrylate. The same shall be applied to “(meth)acryloyl” or the like.

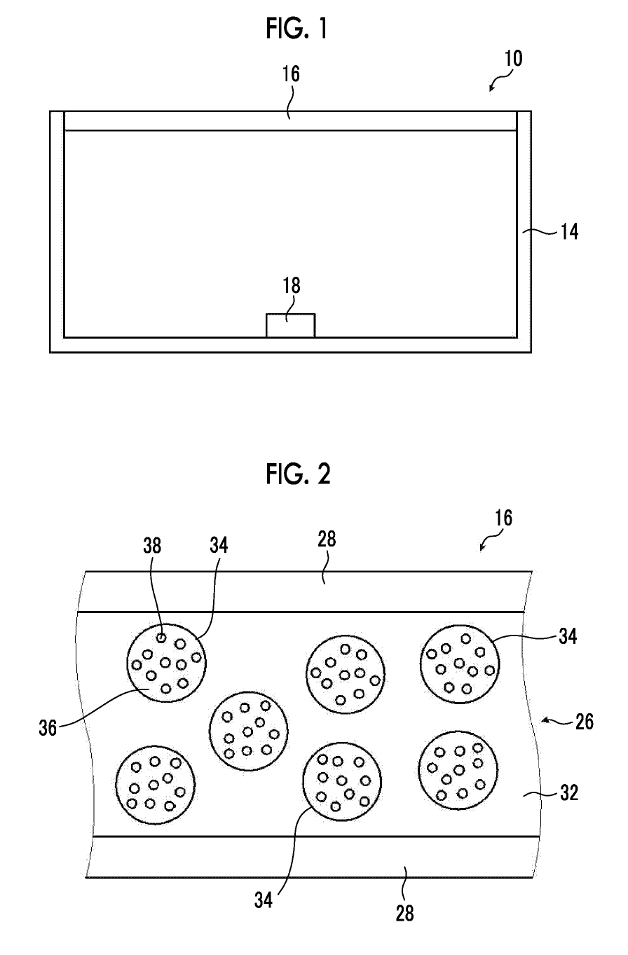

FIG. 1 conceptually illustrates an example of a planar lighting device including a first aspect of the wavelength conversion film according to the present invention.

A planar lighting device 10 is a direct type planar lighting device (backlight unit) used as, for example, a backlight of a liquid crystal display device and includes a case 14, a wavelength conversion film 16, and a light source 18.

In the following description, “liquid crystal display device” will also be referred to as “LCD”. “LCD” is an abbreviation for “Liquid Crystal Display”.

In addition, FIG. 1 is merely a schematic diagram. In addition to the members illustrated in the drawing, the planar lighting device 10 may include various one or more well-known members such as a light emitting diode (LED) substrate, a wiring, or a heat release mechanism that are provided in a well-known planar lighting device such as a backlight of a LCD.

The case 14 is, for example, a rectangular case with a maximum surface opened, and the wavelength conversion film 16 is disposed so as to cover the open surface. The case 14 is a well-known case that is used in, for example, a planar lighting device of a LCD.

In addition, in a preferable aspect, in the case 14, at least a bottom surface as a surface where the light source 18 is provided is a light reflecting surface selected from a mirror surface, a metal reflecting surface, a diffuse reflecting surface, or the like. It is preferable that the entire area of an inner surface of the case 14 is a light reflecting surface.

The wavelength conversion film 16 is a wavelength conversion film that converts a wavelength of incidence light emitted from the light source 18 and emits the light having the converted wavelength. The wavelength conversion film 16 is the wavelength conversion film according to the embodiment of the present invention.

FIG. 2 conceptually illustrates a configuration of the wavelength conversion film 16. The wavelength conversion film 16 includes a wavelength conversion layer 26 and substrates 28 between which the wavelength conversion layer 26 is sandwiched and supported.

In addition, the wavelength conversion layer 26 includes: a binder 32; and microparticles 34 that are dispersed in the binder 32. Although described below in detail, in the wavelength conversion film 16 according to the embodiment of the present invention, the binder 32 of the wavelength conversion layer 26 is a polyvinyl alcohol having a saponification degree in a range of 86 to 97 mol %. In addition, the microparticles 34 are cured product particles of a (meth)acrylate compound including wavelength conversion particles, in which wavelength conversion particles 38 are dispersed in a matrix 36 obtained by curing the (meth)acrylate compound. In the following description, “polyvinyl alcohol” will also be referred to as “PVA”.

The wavelength conversion layer 26 has a function of converting a wavelength of incidence light and emitting the light having the converted wavelength. For example, in a case where blue light emitted from the light source 18 is incident on the wavelength conversion layer 26, the wavelength conversion layer 26 converts a wavelength of at least a part of the blue light into a wavelength of red light or green light due to the effect of the wavelength conversion particles 38 included in the wavelength conversion layer 26 and emits the light having the converted wavelength.

Here, the blue light is light having a center emission wavelength in a wavelength range of 400 to 500 nm. The green light is light having a center emission wavelength in a wavelength range of longer than 500 nm and 600 nm or shorter. The red light is light having a center emission wavelength in a wavelength range of longer than 600 nm and 680 nm or shorter.

The wavelength conversion function that is exhibited by the wavelength conversion layer is not limited to the configuration of converting a wavelength of blue light into a wavelength of red light or green light as long as it converts a wavelength of at least a part of incidence light into another wavelength of light.

The wavelength conversion particles (phosphor particles) 38 are excited by at least incident excitation light to emit fluorescence.

In the wavelength conversion film according to the embodiment of the present invention, the kind of the wavelength conversion particles 38 is not particularly limited, and various well-known wavelength conversion particles can be appropriately selected according to the required wavelength conversion performance or the like.

Examples of the wavelength conversion particles 38 include an organic fluorescent dye, an organic fluorescent pigment, wavelength conversion particles in which a phosphate, an aluminate, a metal oxide, or the like is doped with a rare earth ion, wavelength conversion particles in which a semiconductor material such as a metal sulfide or a metal nitride is doped with an activating ion, and wavelength conversion particles utilizing a quantum confinement effect that are known as quantum dots. Among these, quantum dots that can realize a light source having a narrow emission spectral width and having excellent color reproducibility for use in a display and has an excellent emission quantum efficiency are preferably used as the wavelength conversion particles 38.

That is, in the present invention, as the wavelength conversion layer 26, a wavelength conversion layer in which the microparticles 34 including quantum dots as the wavelength conversion particles 38 are dispersed in the binder 32, that is, a quantum dot layer is preferably used.

The details of the quantum dots can be found in, for example, paragraphs “0060” to “0066” of JP2012-169271A, but the present invention is not limited thereto. In addition, as the quantum dots, a commercially available product can be used without any particular limitation. The emission wavelength of the quantum dots can be typically adjusted by adjusting the composition of particles and the size of particles.

It is preferable that the quantum dots are dispersed uniformly in the microparticles 34. However, the quantum dots may be unevenly dispersed in the microparticles 34. In addition, as the quantum dots, one kind may be used alone, or two or more kinds may be used in combination. In a case where two or more quantum dots are used in combination, two or more kinds of quantum dots having different emission wavelengths may be used.

This point can be applied even in a case where wavelength conversion particles other than the quantum dots are used as the wavelength conversion particles 38.

Specifically, examples of well-known quantum dots include quantum dots (A) having a center emission wavelength in a wavelength range of longer than 600 nm and 680 nm or shorter, quantum dots (B) having a center emission wavelength in a wavelength range of longer than 500 nm and 600 nm or shorter, and quantum dots (C) having a center emission wavelength in a wavelength range of 400 to 500 nm. The quantum dots (A) are excited by the excitation light to emit red light, the quantum dots (B) are excited by the excitation light to emit green light, and the quantum dots (C) are excited by the excitation light to emit blue light.

For example, in a case where blue light is incident as excitation light on the quantum dot layer including the quantum dots (A) and the quantum dots (B), white light can be realized by red light emitted from the quantum dots (A), green light emitted from the quantum dots (B), and blue light having passed through the quantum dot layer. In addition, in a case where ultraviolet light is incident as excitation light on the quantum dot layer including the quantum dots (A), (B), and (C), white light can be realized by red light emitted from the quantum dots (A), green light emitted from the quantum dots (B), and blue light emitted from the quantum dots (C).

In addition, as the quantum dots, for example, so-called quantum rods or tetrapod type quantum dots that have a rod shape and emit polarized light having directivity may be used.

As a described above, in the wavelength conversion layer 26 of the wavelength conversion film 16, the microparticles 34 in which the wavelength conversion particles 38 are dispersed in the matrix 36 are dispersed in the binder 32 and are fixed.

Here, in the wavelength conversion film 16 according to the embodiment of the present invention, the matrix 36 in which the microparticles 34 are dispersed is a cured product of the (meth)acrylate compound. In addition, the binder 32 that fixes the microparticles 34 in the dispersed state is a PVA (including a modified PVA) having a saponification degree in a range of 86 to 97 mol %.

The wavelength conversion film 16 according to the embodiment of the present invention has the above-described configuration. As a result, even in a case where an expensive gas barrier film is used as the substrate 28, deterioration of the wavelength conversion particles 38 such as quantum dots caused by oxygen can be prevented, and the microparticles 34 can be appropriately dispersed in the binder 32 such that the wavelength conversion film having excellent optical characteristics that can emit light without color unevenness and luminance unevenness can be realized.

As described in JP5744033B, a wavelength conversion film in which microparticles including wavelength conversion particles such as quantum dots are dispersed in a binder is known.

Regarding the wavelength conversion film including the microparticles, in order to realize excellent optical characteristics with suppressed color unevenness and luminance unevenness, it is necessary to form the microparticles in which the wavelength conversion particles are appropriately dispersed and to appropriately disperse the microparticles in the binder.

In addition, by using a material having high gas barrier properties as the binder, deterioration of the wavelength conversion particles caused by oxygen can be prevented, and a highly durable wavelength conversion film can be realized.

Here, the wavelength conversion particles such as quantum dots are generally hydrophobic. Accordingly, in the microparticles, in order to hold a sufficient amount of the wavelength conversion particles in the matrix in a state where they are appropriately dispersed without aggregation, it is preferable that a hydrophobic material is used as the matrix.

By using the (meth)acrylate compound among the hydrophobic materials, a sufficient amount of the wavelength conversion particles can be appropriately dispersed without aggregation. In the wavelength conversion film 16 according to the embodiment of the present invention, by using the cured product of the (meth)acrylate compound as the matrix 36 of the microparticles 34, a sufficient amount of the wavelength conversion particles 38 can be appropriately dispersed in the microparticles 34 without aggregation.

On the other hand, in the wavelength conversion film in which the microparticles including the wavelength conversion particles are dispersed in the binder, in general, a resin is used as the binder.

As a resin having high gas barrier properties, polyvinyl alcohol (PVA) is known. Here, in PVA, the saponified hydroxyl group (—OH) portion aggregates due to a hydrogen bond such that the free volume shrinks. Therefore, gas barrier properties are high, and the acetate group (CH₃COO—) portion functions as a main passage of oxygen.

Accordingly, from the viewpoint of gas barrier properties, it is preferable that the saponification degree of the PVA as the binder is high.

However, in a case where the cured product of the (meth)acrylate compound is used as the matrix of the microparticles, that is, the material for forming the microparticles, the acetate group portion in the PVA suitably functions from the viewpoint of the dispersion stability of the methacrylate compound. That is, in a case where the amount of the acetate group is insufficient, the aggregation of the microparticles is caused to occur. Accordingly, from the viewpoint of the stable dispersion of the microparticles, it is not preferable that the saponification degree of the PVA as the binder is excessively high.

The present invention has been made based on the above-described finding. As described above, the cured product of the (meth)acrylate compound is used as the matrix 36 that is the material for forming the microparticles 34 in which the wavelength conversion particles 38 are dispersed and included, and the PVA having a saponification degree of 86% to 97% is used as the binder 32 of the wavelength conversion layer 26.

As a result, the wavelength conversion film having excellent optical characteristics can be realized, in which deterioration of the wavelength conversion particles 38 caused by oxygen can be prevented such that the durability is excellent, and the microparticles 34 in which a sufficient amount of the wavelength conversion particles 38 are appropriately dispersed and included are appropriately dispersed in the binder 32 such that light having no color unevenness and luminance unevenness can be emitted.

In the present invention, the material for forming the matrix 36 of the microparticles 34 is the cured product of the (meth)acrylate compound. Specifically, the matrix 36 can be formed by curing (polymerization and crosslinking) various well-known monofunctional (meth)acrylate monomers and/or polyfunctional (meth)acrylate monomers.

As the monofunctional (meth)acrylate monomer, for example, acrylic acid, methacrylic acid, or a derivative thereof can be used. More specifically, an aliphatic or aromatic monomer having one polymerizable unsaturated bond (meth)acryloyl group of (meth)acrylic acid in the molecule and having 1 to 30 carbon atoms in the alkyl group can be used. Hereinafter, specific examples of the monofunctional (meth)acrylate monomer include the following compounds, but the present invention is not limited thereto.

Examples of the aliphatic monofunctional (meth)acrylate monomer include:

an alkyl (meth)acrylate with an alkyl group having 1 to 30 carbon atoms such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, or stearyl (meth)acrylate;

an alkoxyalkyl (meth)acrylate with an alkoxyalkyl group having 2 to 30 carbon atoms such as butoxyethyl (meth)acrylate;

an aminoalkyl (meth)acrylate with a (monoalkyl or dialkyl)aminoalkyl group having 1 to 20 carbon atoms in total such as N,N-dimethylaminoethyl (meth)acrylate;

a polyalkylene glycol alkyl ether (meth)acrylate with an alkylene chain having 1 to 10 carbon atoms and a terminal alkyl ether having 1 to 10 carbon atoms such as diethylene glycol ethyl ether (meth)acrylate, triethylene glycol butyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, or tetraethylene glycol monoethyl ether (meth)acrylate;

a polyalkylene glycol aryl ether (meth)acrylate with an alkylene chain having 1 to 30 carbon atoms and a terminal aryl ether having 6 to 20 carbon atoms such as hexaethylene glycol phenyl ether (meth)acrylate;

a (meth)acrylate having an alicyclic structure and having 4 to 30 carbon atoms in total such as cyclohexyl (meth)acrylate, dicyclopentanyl (meth)acrylate, isobornyl (meth)acrylate, or a methylene oxide adduct of cyclodecatriene (meth)acrylate;

a fluorinated alkyl(meth)acrylate having 4 to 30 carbon atoms in total such as heptadecafluorodecyl (meth)acrylate;

a (meth)acrylate having a hydroxyl group such as 2-hydroxyethyl (meth)acrylate, 3-hydroxypropyl (meth)acrylate, 4-hydroxybutyl (meth)acrylate, triethylene glycol mono(meth)acrylate, tetraethylene glycol mono(meth)acrylate, hexaethylene glycol mono(meth)acrylate, octapropylene glycol mono(meth)acrylate, or glycerol mono(meth)acrylate;

a (meth)acrylate having a glycidyl group such as glycidyl (meth)acrylate;

a polyethylene glycol mono(meth)acrylate with an alkylene chain having 1 to 30 carbon atoms such as tetraethylene glycol mono(meth)acrylate, hexaethylene glycol mono(meth)acrylate, or octapropylene glycol mono(meth)acrylate; and

a (meth)acrylamide such as (meth)acrylamide, N,N-dimethyl (meth)acrylamide, N-isopropyl (meth)acrylamide, 2-hydroxyethyl (meth)acrylamide, or acryloylmorpholine.

As the aromatic monofunctional acrylate monomer, an aralkyl (meth)acrylate having 7 to 20 carbon atoms in the aralkyl group, for example, benzyl (meth)acrylate can be used.

In particular, an aliphatic or aromatic alkyl (meth)acrylate having 4 to 30 carbon atoms in the alkyl group is preferable, and n-octyl (meth)acrylate, lauryl (meth)acrylate, stearyl (meth)acrylate, cyclohexyl (meth)acrylate, dicyclopentanyl (meth)acrylate, isobornyl (meth)acrylate, or a methylene oxide adduct of cyclodecatriene (meth)acrylate is more preferable.

As a result, the dispersibility of the wavelength conversion particles 38 such as quantum dots in the microparticles 34 is improved. As the dispersibility of the wavelength conversion particles 38 is improved, the amount of light directed from the wavelength conversion layer 26 to an emission surface increases, which is efficient for improving front luminance and front contrast.

In addition, preferable examples of the bifunctional (meth)acrylate monomer among the bifunctional or higher polyfunctional (meth)acrylate monomers include neopentyl glycol di(meth)acrylate, 1,6-hexanediol di(meth)acrylate, 1,9-nonanediol di(meth)acrylate, 1,10-decanediol diacrylate, tripropylene glycol di(meth)acrylate, ethylene glycol di(meth)acrylate, tetraethylene glycol di(meth)acrylate, hydroxypivalic acid neopentyl glycol di(meth)acrylate, polyethylene glycol di(meth)acrylate, tricyclodecane dimethanol diacrylate, and ethoxylated bisphenol A diacrylate.

In addition, preferable examples of a trifunctional (meth)acrylate monomer among the bifunctional or higher (meth)acrylate monomers include epichlorohydrin (ECH)-modified glycerol tri(meth)acrylate; ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified wavelength conversion particlesic acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, dipentaerythritol penta(meth)acrylate, caprolactone-modified dipentaerythritol hexa(meth)acrylate, dipentaerythritol hydroxy penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, and pentaerythritol tetra(meth)acrylate.

In addition, as the polyfunctional monomer, a (meth)acrylate monomer having a urethane bond in the molecule, specifically, an adduct of tolylene diisocyanate (TDI) and hydroxyethyl acrylate, an adduct of isophorone diisocyanate (IPDI) and hydroxyethyl acrylate, an adduct of hexamethylene diisocyanate (HDI) and pentaerythritol triacrylate (PETA), a compound obtained by a reaction of residual isocyanate, which remains after preparation of an adduct of TDI and PETA, and dodecyloxyhydroxypropyl acrylate, an adduct of nylon 6,6 and TDI, or an adduct of pentaerythritol, TDI, and hydroxyethyl acrylate can also be used.

Plural kinds selected from the above (meth)acrylate monomers may be used in combination.

Further, a commercially available product can be used as the (meth)acrylate monomer.

In addition, in addition to the matrix 36 and the wavelength conversion particles 38, the microparticles 34 may optionally include a polymerization initiator, a viscosity adjuster, a thixotropic agent, a hindered amine compound, organic particles, inorganic particles, or a surfactant.

Although described below, the microparticles 34 are formed using a method including: adding and dispersing the wavelength conversion particles 38 to and in the liquid (meth)acrylate compound for forming the matrix 36 to prepare a dispersion; putting the dispersion to an aqueous solution in which PVA for forming the binder 32 described below is dissolved to prepare an emulsion; and curing the (meth)acrylate monomer of the dispersion.

That is, “the microparticles 34 may include a polymerization initiator” represents that the dispersion for forming the microparticles 34 may optionally include a polymerization initiator in other words.

The average particle size of the microparticles 34 is not particularly limited and may be appropriately set according to the thickness of the wavelength conversion layer 26, the content of the microparticles 34 in the wavelength conversion layer 26, and the like. The average particle size of the microparticles 34 is preferably 0.5 to 5 μm.

The average particle size of the microparticles 34 is preferably 0.5 μm or more from the viewpoint that the microparticles 34 can be dispersed in the binder 32 without aggregation.

The average particle size of the microparticles 34 is preferably 5 μm or less from the viewpoint that, for example, the thickness of the wavelength conversion layer 26 can be reduced.

The average particle size of the microparticles 34 may be measured with a well-known method using an optical microscope, an electron microscope, a particle size distribution analyzer, or the like. For example, the average particle size of the microparticles 34 may be calculated using a method including: cutting the wavelength conversion layer 26 with a microtome or the like to form a cross-section; observing the cross-section with an optical microscope to obtain an image; and analyzing the obtained image using image analysis software.

The average particle size of the microparticles may be controlled using a well-known method. Examples of the control method include a method of adjusting a stirring rate in a step of preparing an emulsion described below, a method of adjusting emulsion conditions in the step of preparing an emulsion described below, and a method adjusting a PVA concentration in a PVA aqueous solution used for the preparation of the emulsion.

The content of the wavelength conversion particles 38 in the microparticles 34 is not particularly limited and may be appropriately set according to the kind of the wavelength conversion particles 38 to be used, the average particle size of the microparticles 34, and the like. The content of the wavelength conversion particles 38 in the microparticles 34 is preferably 0.1 to 10 mass % and more preferably 0.3 to 3 mass %.

The content of the wavelength conversion particles 38 in the microparticles 34 is preferably 0.1 mass % or higher from the viewpoint that, for example, a sufficient amount of the wavelength conversion particles 38 can be held to realize high-luminance emission.

The content of the wavelength conversion particles 38 in the microparticles 34 is preferably 10 mass % or lower from the viewpoint that, for example, the wavelength conversion particles 38 can be suitably dispersed in the microparticles 34 to realize high-luminance emission with a high quantum yield.

The binder 32 of the wavelength conversion layer 26 can hold the microparticles 34 including the wavelength conversion particles 38 to be formed in the matrix 36 in the dispersed state In the present invention, as described above, the binder 32 of the wavelength conversion layer 26 is a polyvinyl alcohol (PVA) having a saponification degree in a range of 86 to 97 mol %.

In a case where the saponification degree of the PVA for forming the binder 32 is lower than 86 mol %, the gas barrier properties of the binder 32 are insufficient, and there is a problem in that, for example, deterioration of the wavelength conversion particles 38 such as quantum dots caused by oxygen cannot be sufficiently prevented.

In a case where the saponification degree of the PVA for forming the binder 32 is higher than 97 mol %, the microparticles 34 cannot be appropriately dispersed in the binder 32, and there is a problem in that, for example, optical characteristics deteriorate.

The saponification degree of the PVA for forming the binder 32 is preferably in a range of 88 to 95 mol %.

The polymerization degree, and the average molecular weight (weight-average molecular weight and number-average molecular weight) of the PVA (modified PVA) for forming the binder 32 are not particularly limited as long as the PVA has a saponification degree in a range of 86 to 97 mol %.

In a case where the PVA has a low molecular weight, the handleability is excellent in the method of manufacturing the wavelength conversion film according to the embodiment of the present invention.

As the PVA, a modified PVA can also be preferably used.

Preferable examples of the modified PVA include carboxy modified PVA and carbonyl modified PVA.

Further, examples of the modifying group of the modified PVA include a hydrophilic group (for example, a carboxylate group, a sulfonate group, a phosphonate group, an amino group, an ammonium group, an amido group, or a thiol group), a hydrocarbon group having 10 to 100 carbon atoms, a fluorine-substituted hydrocarbon group, a thioether group, a polymerizable group (for example, an unsaturated polymerizable group, an epoxy group, or an aziridinyl group), and an alkoxysilyl group (trialkoxy, dialkoxy, or monoalkoxy). Specific examples of the modified polyvinyl alcohol compound include examples described in paragraph “0074” of JP2000-056310A, paragraphs “0022” to “0145” of JP2000-155216A, and paragraphs “0018” to “0022” of JP2002-062426A. The modifying group of the modified PVA can be introduced, for example, by copolymerization modification, chain transfer modification, or block polymerization modification.

In the wavelength conversion film according to the embodiment of the present invention, the content of the microparticles 34 in the wavelength conversion layer 26 may be appropriately set according to the particle size of the microparticles 34, the content of the wavelength conversion particles 38 in the microparticles 34, the saponification degree of the PVA for forming the binder 32, and the like, and is preferably 6 to 60 vol % and more preferably 20 to 40 vol %.

The content of the microparticles 34 in the wavelength conversion layer 26 is preferably 6 vol % or higher from the viewpoints that, for example, light having a sufficient luminance can be emitted and the thickness of the wavelength conversion layer 26, that is, the wavelength conversion film 16 can be reduced.

The content of the microparticles 34 in the wavelength conversion layer 26 is preferably 60 vol % or lower from the viewpoints that, for example, the effect of the binder 32 preventing deterioration of the wavelength conversion particles 38 can be suitably obtained and the microparticles 34 can be suitably dispersed in the wavelength conversion layer 26.

The content of the microparticles 34 in the wavelength conversion layer 26 may be measured using a well-known method. For example, the content of the microparticles 34 may be measured using a well-known method using an optical microscope, an electron microscope, or the like. For example, the content of the microparticles 34 may be measured using a method including: cutting the wavelength conversion layer 26 with a microtome or the like to form a cross-section; observing the cross-section with an optical microscope to obtain an image; and analyzing the obtained image using image analysis software or the like.

In addition, the wavelength conversion layer 26 may optionally include an emulsifier or a silane coupling agent.

Although described below, the wavelength conversion layer 26 can be formed using a method including: preparing the dispersion for forming the microparticles 34; putting the dispersion to an aqueous solution in which PVA for forming the binder 32 is dissolved to be emulsified; curing the (meth)acrylate compound for forming the matrix 36 to prepare a coating solution in which the microparticles 34 are dispersed and emulsified in the aqueous solution; applying the coating solution to the substrate 28 described below; and drying the applied coating solution.

That is, “the wavelength conversion layer 26 may include an emulsifier” represents that the coating solution for forming the wavelength conversion layer 26 may optionally include an emulsifier in other words.

The wavelength conversion layer 26 may have a single-layer configuration or may have a multiplayer configuration including two or more layers.

In a case where the wavelength conversion layer 26 has a multiplayer configuration, emission wavelengths of wavelength conversion particles included in the wavelength conversion layers may be different from each other. Examples of a two-layer configuration include a configuration in which one layer includes the above-described quantum dots (A) that are excited by excitation light (blue light) to emit red light and another layer includes the above-described quantum dots (B) that are excited by excitation light (blue light) to emit green light.

The thickness of the wavelength conversion layer 26 is not particularly limited and may be appropriately set according to the thickness of the wavelength conversion film 16, the wavelength conversion particles 38 to be used, the saponification degree of the PVA for forming the binder 32, and the like.

The thickness of the wavelength conversion layer 26 is preferably 10 to 100 μm.

It is preferable that the thickness of the wavelength conversion layer 26 is 10 μm or more from the viewpoint that, for example, the wavelength conversion layer 26 that emits light with a sufficient luminance can be obtained.

It is preferable that the thickness of the wavelength conversion layer 26 is 100 μm or less from the viewpoint that, for example, an unnecessary increase in the thickness of the wavelength conversion film 16 can be prevented.

As the substrate 28, various film-like materials (sheet-like materials) that are used for a well-known wavelength conversion film can be used. Accordingly, as the substrate 28, various film-like materials that can support the wavelength conversion layer 26 and the coating solution for forming the wavelength conversion layer 26 can be used.

Here, the substrate 28 is preferably transparent. For example, glass, a transparent inorganic crystalline material, or a transparent resin material can be used. In addition, the substrate 28 may be a rigid sheet-like material or a flexible film-like material. Further, the substrate 28 may have an elongated material that can be wound or a cut sheet material having a predetermined dimension.

As the substrate 28, films formed of various resin materials (polymer materials) can be suitably used from the viewpoints that, for example, a reduction in thickness and weight is easy and the flexibility is high.

Preferable examples of the films include resin films formed of polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), ABS, a cycloolefin copolymer (COC), a cycloolefin polymer (COP), and triacetyl cellulose (TAC).

In addition, a gas barrier film in which a gas barrier layer exhibiting gas barrier properties is formed on the resin film can also be used as the substrate 28.

Here, the oxygen permeability of the substrate 28 is not particularly limited.

In the wavelength conversion film 16 according to the embodiment of the present invention, the PVA having a saponification degree in a range of 86 to 97 mol % is used as the binder 32 of the wavelength conversion layer 26. Therefore, deterioration of the wavelength conversion particles 38 such as quantum dots caused by oxygen can be prevented due to the gas barrier properties of the binder 32.

Thus, deterioration of the wavelength conversion particles 38 caused by oxygen can be sufficient prevented even without using a gas barrier film having high gas barrier properties in which, for example, the oxygen permeability is 1×10⁻³ cc/(m²·day·atm) or lower as the substrate 28, and the highly durable wavelength conversion film 16 can be obtained.

In addition, the film having a low oxygen permeability, that is, the film having high gas barrier properties is a film a dense film having a high density or a film including a dense layer having a high density, and thus may deteriorate the optical characteristics of the wavelength conversion film 16. In addition, the film having high gas barrier properties is expensive.

On the other hand, in the wavelength conversion film 16 according to the embodiment of the present invention, it is not necessary to use the film having high gas barrier properties as the substrate 28. Therefore, deterioration in the optical characteristics of the wavelength conversion film 16 caused by the substrate 28 can be prevented, and the costs of the wavelength conversion film 16 can be reduced.

The wavelength conversion film 16 illustrated in FIG. 2 has the configuration in which the wavelength conversion layer 26 is sandwiched between the substrates 28 corresponding to opposite main surfaces of the wavelength conversion layer 26. However, the present invention is limited to the configuration. That is, the wavelength conversion film 16 according to the embodiment of the present invention may have a configuration in which the substrate 28 is provided only on one main surface of the wavelength conversion layer 26. The main surface refers to a maximum surface of a layer, a film-like material, or the like.

However, in the wavelength conversion film 16 according to the embodiment of the present invention, it is preferable that the wavelength conversion layer 26 is sandwiched between the substrate 28 from the viewpoints that, for example, the wavelength conversion layer 26 can be suitably protected and the amount of gas infiltrated into the wavelength conversion layer 26 can be reduced.

In a case where the wavelength conversion layer 26 is sandwiched between the substrates 28, the two substrates may be the same as or different from each other.

In addition, the thickness of the substrate 28 is preferably 5 to 100 more preferably 10 to 70 and still more preferably 15 to 55 μm.

It is preferable that the thickness of the substrate 28 is 5 μm or more from the viewpoints that, for example, the wavelength conversion layer 26 can be suitably held and protected and deterioration of the wavelength conversion particles 38 caused by oxygen can be prevented.

It is preferable that the thickness of the substrate 28 is 100 μm or less from the viewpoint that, for example, the total thickness of the wavelength conversion film 16 including the wavelength conversion layer 26 can be reduced.

A method of preparing the wavelength conversion film 16 is not particularly limited, and various well-known methods of preparing a laminated film in which a layer that exhibits an optical function is sandwiched between resin films or the like or one surface thereof is supported can be used.

For example, a preferable method of preparing the wavelength conversion film 16 is as follows.

The wavelength conversion particles 38 such as quantum dots are put into a liquid (uncured) (meth)acrylate compound, optionally a polymerization initiator or the like is further put thereinto, and the components are stirred. As a result, a dispersion in which the wavelength conversion particles 38 are dispersed in the liquid (meth)acrylate compound for forming the matrix 36 is prepared. The content of the wavelength conversion particles 38 in the dispersion is the content of the wavelength conversion particles 38 in the microparticles 34 to be formed.

On the other hand, an aqueous solution in which a water-soluble polymer for forming the binder 32 is dissolved in water is prepared. In this embodiment, since PVA is used for forming the binder 32, an aqueous solution of PVA (PVA aqueous solution) in which PVA (modified PVA) for forming the binder 32 is dispersed in water is prepared. As the water, pure water or ion exchange water is preferably used.

The concentration of the aqueous solution is not particularly limited, and may be appropriately set according to the amount of the dispersion described below put and the like. The concentration of the aqueous solution is preferably 5 to 60 mass %.

Next, the dispersion is put into the aqueous solution in which the PVA is dissolved in water, optionally an emulsifier or the like is further added thereinto, and the components are stirred. As a result, an emulsion in which the dispersion is dispersed and emulsified in the aqueous solution is prepared.

As is well known, the (meth)acrylate compound for forming the matrix 36 is hydrophobic, and the wavelength conversion particles 38 are also hydrophobic. Further, the PVA for forming the binder 32 is hydrophilic. Therefore, the dispersion is dispersed in the aqueous solution in a liquid droplet state where the wavelength conversion particles 38 are included in liquid droplets of the (meth)acrylate compound for forming the matrix 36. In other words, the emulsion is in a state where the liquid droplets of the (meth)acrylate including the wavelength conversion particles 38 are dispersed and emulsified in the aqueous solution.

In order to prepare the emulsion, in addition to stirring, various dispersion methods or emulsion methods such as a method using a homogenizer or film emulsion can be used. This point shall be applied to the preparation of the above-described dispersion.

After the preparation of the emulsion, the (meth)acrylate compound for forming the matrix 36 is cured (crosslinking and polymerization) using a method such as ultraviolet irradiation or heating while maintaining the emulsion state.

As a result, the microparticles 34 in which the wavelength conversion particles 38 are dispersed in the cured product of the (meth)acrylate compound, that is, in the matrix 36 are formed, the microparticles 34 are dispersed and emulsified in the aqueous solution of the PVA for forming the binder 32, and thus the coating solution is prepared.

On the other hand, two substrates 28 such as a PET film are prepared.

After the preparation of the coating solution and the preparation of the substrate 28, the coating solution is applied to one surface of one substrate 28, and the applied coating solution is heated and dried. As a result, the wavelength conversion layer 26 is formed.

A method of applying the coating solution is not particularly limited, and various coating methods such as a spin coating method, a die coating method, a bar coating method, or a spray coating method can be used.

In addition, a method of heating and drying the coating solution is not particularly limited, and various well-known methods of drying an aqueous solution such as heating drying using a heater, heating drying using warm air, or heating drying using a heater and warm air in combination can be used.

In the method of manufacturing the wavelength conversion film according to the embodiment of the present invention, the wavelength conversion particles 38 such as quantum dots are dispersed in the (meth)acrylate compound for forming the matrix 36 to obtain a dispersion, the obtained dispersion is dispersed in the aqueous solution of PVA for forming the binder 32 to prepare a coating solution, and this coating solution is applied to the substrate 28 and dried. As a result, the wavelength conversion layer 26 is formed. Therefore, the wavelength conversion film 16 can be relatively simply manufactured.

After the formation of the wavelength conversion layer 26, another substrate 28 is laminated on and bonded to a surface of the wavelength conversion layer 26 where the substrate 28 is not laminated. As a result, the wavelength conversion film 16 illustrated in FIG. 2 is prepared.

The bonding of the substrate 28 may be performed using the viscosity or adhesiveness of the wavelength conversion layer 26 or may be performed by optionally using an adhesive, an adhesive layer, or an adhesive sheet such as a transparent pressure sensitive adhesive, a transparent pressure sensitive adhesive sheet, or an optical clear adhesive (OCA).

In a case where the wavelength conversion film in which the substrate 28 is provided only on one main surface of the wavelength conversion layer 26 is prepared, the preparation of the wavelength conversion film may end when the coating solution is heated and dried to form the wavelength conversion layer 26.

In a second aspect of the wavelength conversion film according to the embodiment of the present invention, as the binder of the wavelength conversion layer, a copolymer of butene diol and vinyl alcohol, that is, a butene diol-vinyl alcohol copolymer is used instead of PVA used in the first aspect. In the following description, “the copolymer of butene diol and vinyl alcohol” will also be referred to as “BVOH”.

The second aspect of the wavelength conversion film according to the embodiment of the present invention is the same as the above-described wavelength conversion film 16, except that BVOH is used as the binder of the wavelength conversion layer instead of PVA. Accordingly, the matrix 36 and the wavelength conversion particles 38 of the microparticles 34, the substrate 28, and the like are the same as those of the wavelength conversion film 16 according to the first aspect.

In addition, the thickness of the wavelength conversion layer, the content of the microparticles in the wavelength conversion layer, and the like may be set based on the wavelength conversion film 16 according to the first aspect.

In the present invention, as the BVOH, various well-known materials can be used, and the average molecular weight (weight-average molecular weight and number-average molecular weight), the saponification degree, the ratio between butene diol and vinyl alcohol, and the like thereof are not particularly limited.

In addition, as the BVOH, a commercially available product can also be suitably used. Examples of the commercially available product of the BVOH include G-polymer series (G-polymer™, manufactured by The Nippon Synthetic Chemical Industry Co., Ltd.).

In addition, the wavelength conversion film in which BVOH is used as the binder can be prepared by using BVOH instead of PVA in the above-described method of manufacturing the wavelength conversion film 16 according to the first aspect.

That is, the wavelength conversion film may be prepared using the same method as the above-described method of manufacturing the wavelength conversion film 16 according to the first aspect, except that an aqueous solution of BVOH in which BVOH is dissolved in water as the water-soluble polymer for forming the binder instead of PVA is prepared.

In the planar lighting device 10, the light source 18 is disposed at a center position of a bottom surface in the case 14. The light source 18 is a light source of light emitted from the planar lighting device 10.

As the light source 18, various well-known light sources can be used as long as they emit light having a wavelength that is converted by the wavelength conversion particles 38 of the wavelength conversion film 16 (the wavelength conversion layer 26) such as quantum dots.

In particular, for example, a light emitting diode (LED) is preferably used as the light source 18. In addition, as the wavelength conversion layer 26 of the wavelength conversion film 16, the quantum dot layer in which quantum dots are dispersed in the matrix such as a resin is preferably used. Therefore, as the light source 18, a blue LED that emits blue light is preferably used, and a blue LED having a peak wavelength of 450 nm±50 nm is more preferably used.

In the planar lighting device 10 according to the embodiment of the present invention, the output of the light source 18 is not particularly limited and may be appropriately set according to the illuminance (luminance) of light required for the planar lighting device 10.

In addition, in the planar lighting device 10 according to the embodiment of the present invention, one light source 18 may be provided as illustrated in the drawing, or a plurality of light sources 18 may be provided.

The planar lighting device 10 illustrated in FIG. 1 is a so-called direct type planar lighting device, but the present invention is not limited thereto. The present invention is suitably applicable to a so-called edge light type planar lighting device (backlight unit) used for a light guide plate.

In this case, for example, an edge light type planar lighting device may be configured by disposing a light guide plate and the wavelength conversion film 16 according to the embodiment of the present invention such that one main surface of the wavelength conversion film 16 faces a light incident surface of the light guide plate, sandwiching the wavelength conversion film 16 between the light guide plate and the wavelength conversion film 16, and disposing the light source 18 on a surface opposite to the light guide plate. In the edge light type planar lighting device, a plurality of light sources 18 may be typically disposed in a longitudinal direction of the light incident surface of the light guide plate, or an elongated light source may be disposed such that a longitudinal direction thereof matches the longitudinal direction of the light incident surface of the light guide plate.

Hereinabove, the wavelength conversion film according to the embodiment of the present invention and the method of manufacturing the wavelength conversion film have been described in detail. However, the present invention is not limited to the above-described examples, and various improvements and modifications can be made within a range not departing from the scope of the present invention.

### EXAMPLES

Hereinafter, the present invention will be described in more detail using specific examples according to the present invention. The present invention is not limited to Examples described below, and materials, used amounts, ratios, treatment details, treatment procedures, and the like shown in the following examples can be appropriately changed within a range not departing from the scope of the present invention.

### Example 1

<Preparation of Dispersion>

A dispersion having the following composition was prepared.
Toluene dispersion (maximum emission wavelength: 530 nm) including quantum dots 1: 20 mass %
Toluene dispersion (maximum emission wavelength: 630 nm) including quantum dots 2: 2 mass %
Dicyclopentanyl acrylate (DCP) (FA-513AS, manufactured by Hitachi Chemical Co., Ltd.): 97 mass %
Photopolymerization initiator (IRGACURE TPO, manufactured by BASF SE): 2 mass %

As the quantum dots 1 and 2 that were wavelength conversion particles, nanocrystals having the following core-shell structure (InP/ZnS) were used.
Quantum dots 1: INP530-10 (manufactured by NN-Labs LLC.)
Quantum dots 2: INP620-10 (manufactured by NN-Labs LLC.)

Toluene was removed under reduced pressure while heating the obtained solution at 40° C. using an evaporator. As a result, a dispersion in which the quantum dots were dispersed in DCP was prepared.

<Preparation of PVA Aqueous Solution>

As PVA for forming the binder of the wavelength conversion layer, PVA 203 (manufactured by Kuraray Co., Ltd.) was used. The saponification degree of the PVA was 87 to 89 mol %.

This PVA was put into pure water and was stirred to dissolve the binder while heating the solution at 80° C. As a result, an aqueous solution of PVA (PVA aqueous solution) in which PVA for forming the binder was dissolved in pure water was prepared. The concentration of the PVA in the PVA aqueous solution was 30 mass %.

<Preparation of Emulsion and Coating Solution>

Using the dispersion and the PVA aqueous solution prepared, a mixed solution having the following composition was prepared.
Dispersion: 5.8 parts by mass
PVA aqueous solution: 93.7 parts by mass
1 mass % aqueous solution of sodium dodecylsulfate (SDS, manufactured by Tokyo Chemical Industry Co., Ltd.): 0.5 parts by mass

50 cc of the mixed solution having the above-described composition and a stirrer (magnetic stirrer) were put into a ϕ35 mm vial. All the preparation operations of the mixed solution were performed in a glove box having an oxygen concentration of 300 ppm or lower. Further, the vial was covered to hold the inside in a nitrogen purged state.

The vial into which the mixed solution and the stirrer were put was extracted from the glove box and was stirred using the stirrer at 1500 rpm for 30 minutes. As a result, an emulsion was prepared.

Next, while stirring the emulsion to maintain the emulsified state, the entire emulsion was irradiated with ultraviolet light using an air-cooled metal halide lamp (manufactured by Eye Graphics Co., Ltd.) of 160 W/cm to cure the matrix (DCP) of the dispersion and to form microparticles. As a result, the microparticles were dispersed and emulsified in the PVA aqueous solution in which the PVA for forming the binder was dissolved, and thus a coating solution was prepared. The irradiation time of the ultraviolet light was 120 seconds.

<Preparation of Wavelength Conversion Film>

As a substrate, a PET film (COSMOSHINE A4300, manufactured by Toyobo Co., Ltd., thickness: 50 μm) was prepared.

The prepared coating solution was applied to one surface of the PET film using a die coater. Next, the coating solution was dried using a heater at 90° C. for 30 minutes. As a result, a wavelength conversion layer was formed on the PET film. The thickness of the formed wavelength conversion layer was 70 μm.

In a case where the obtained wavelength conversion layer was cut using a microtome to form a cross-section, and the cross-section was observed with an optical microscope (reflected light), it was found that the microparticles in which the phosphor (quantum dots) was dispersed in the matrix were dispersed in the wavelength conversion layer. In addition, in a case where the obtained optical microscope image was analyzed using image analysis software (ImageJ), the average particle size (primary particle size) of the microparticles was 5.8 μm.

Next, a PET film (substrate) was laminated on the formed wavelength conversion layer and was bonded thereto using a pressure sensitive adhesive (8172CL, manufactured by 3M). As a result, a wavelength conversion film illustrated in FIG. 2 in which the wavelength conversion layer was sandwiched between the two substrates was prepared.

### Example 2

A wavelength conversion film was prepared using the same method as in Example 1, except that PVA-CST (manufactured by Kuraray Co., Ltd.) was used as the PVA for forming the binder instead of PVA 203. The saponification degree of the PVA was 95.5 to 96.5 mol %.

In a case where the measurement was performed using the same method as that of Example 1, the average particle size of the microparticles was 5.9 μm.

### Example 3

A wavelength conversion film was prepared using the same method as in Example 1, except that modified PVA (AP-17, manufactured by Japan Vam&Poval Co., Ltd.) was used as the PVA for forming the binder instead of PVA 203. The saponification degree of the modified PVA was 88 to 90 mol %.

In a case where the measurement was performed using the same method as that of Example 1, the average particle size of the microparticles was 6.0 μm.

### Example 4

A wavelength conversion film was prepared using the same method as in Example 1, except that the concentration of the PVA in the PVA aqueous solution was changed to 32 mass %.

In a case where the measurement was performed using the same method as that of Example 1, the average particle size of the microparticles was 4.6 μm.

### Example 5

A wavelength conversion film was prepared using the same method as in Example 1, except that PVA-CST (manufactured by Kuraray Co., Ltd.) was used as the PVA for forming the binder instead of PVA 203, and the concentration of the PVA in the PVA aqueous solution was changed to 35 mass %.

In a case where the measurement was performed using the same method as that of Example 1, the average particle size of the microparticles was 0.6 μm.

### Example 6

A wavelength conversion film was prepared using the same method as in Example 1, except that BVOH (G-polymer OKS-6026, manufactured by The Nippon Synthetic Chemical Industry Co., Ltd.) was used as the binder instead of PVA (PVA 203).

In a case where the measurement was performed using the same method as that of Example 1, the average particle size of the microparticles was 6.1 μm.

### Comparative Example 1

A wavelength conversion film was prepared using the same method as in Example 1, except that PVA 103 (manufactured by Kuraray Co., Ltd.) was used as the PVA for forming the binder instead of PVA 203. The saponification degree of the PVA was 98 to 99 mol %.

In a case where the measurement was performed using the same method as that of Example 1, the average particle size of the microparticles was 5.2 μm. Several to several hundreds of the microparticles aggregated to form a secondary aggregate.

### Comparative Example 2

A wavelength conversion film was prepared using the same method as in Example 1, except that PVA 405 (manufactured by Kuraray Co., Ltd.) was used as the PVA for forming the binder instead of PVA 203. The saponification degree of the PVA was 80 to 83 mol %.

In a case where the measurement was performed using the same method as that of Example 1, the average particle size of the microparticles was 6.2 μm.

[Measurement of Durability]

<Preparation of Planar Lighting Device>

A commercially available tablet terminal (trade name “Kindle” (registered trade name) Fire HDX7″, manufactured by Amazon Co., Ltd.) including a blue light source in a backlight unit was disassembled to extract the backlight unit. Instead of a wavelength conversion film quantum dot enhancement film (QDEF) incorporated into the backlight unit, each of wavelength conversion films according to Examples and Comparative Examples cut in a rectangular shape (50×50 mm) was incorporated. This way, a planar lighting device was prepared.

The prepared planar lighting device was turned on, and an initial luminance value Y₀ (cd/m²) thereof was measured using a luminance colorimeter (trade name: “SR3”, manufactured by Topcon Corporation) that was provided at a distance of 520 mm from a surface of a light guide plate in the vertical direction such that the entire surface was displayed white.

Next, the wavelength conversion film was extracted from the planar lighting device, was put into a constant-temperature tank held at 60° C. and a relative humidity of 90%, and was stored for 1000 hours. After 1000 hours, the wavelength conversion film was extracted from the constant-temperature tank, a planar lighting device was prepared using the same method, and a luminance value Y1 (cd/m²) after a high-temperature and high-humidity test was measured according to the same procedure as described above.

Based on the measured initial luminance value Y0 and the measured luminance value Y1 after the high-temperature and high-humidity test, a change rate ΔY of the luminance value Y1 after the high-temperature and high-humidity test from the initial luminance value Y0 was calculated by the following expression. Using the change rate ΔY, the durability of the wavelength conversion film was evaluated based on the following standards.

ΔY[%]=(Y0−Y1)/Y0×100

ΔY≤5% A:

5%<ΔY<15% B:

15%≤ΔY C:

[Measurement of Color Unevenness]

A planar lighting device was prepared using the same method as that of the measurement of the luminance value Y0 in the measurement of the durability, a CIE x,y chromaticity was measured using the same measurement method as described above, and a chromaticity variation value Δxy was calculated from an average value of in-plane 9 points. Using the chromaticity variation value Δxy, the color unevenness was evaluated based on the following standards.

Δxy≤0.005 A:

0.005<Δxy≤0.010 B:

0.010<Δxy≤0.015 C:

0.015<Δxy D:

The results are shown in the following table.

TABLE 1

| | Binder | | Micro- | | |
|---|---|---|---|---|---|
| | | Sapon- | particles | | |
| | | ification | Average | Evaluation | |
| | | Degree | Particle | Dura- | Color |
| | Kind | [mol %] | Size [μm] | bility | Unevenness |
| Example 1 | PVA | 87 to 89 | 5.8 | B | A |
| Example 2 | PVA | 95.5 to 96.5 | 5.9 | A | B |
| Example 3 | Modified | 88 to 90 | 6.0 | A | A |
| | PVA | | | | |
| Example 4 | PVA | 87 to 89 | 4.6 | A | A |
| Example 5 | PVA | 95.5 to 96.5 | 0.6 | A | A |
| Example 6 | BVOH | — | 6.1 | A | A |
| Comparative | PVA | 98 to 99 | 5.2 | A | C |
| Example 1 | | | | | |
| Comparative | PVA | 80 to 83 | 6.2 | C | A |
| Example 2 | | | | | |

As shown in the table, in the wavelength conversion film according to the embodiment of the present invention, the durability is excellent, and planar light having no color unevenness can be suitably emitted. In particular, in Example 3 in which modified PVA was used as the binder, in Examples 4 and 5 in which the average particle size of the microparticles was in a preferable range, and in Example 6 in which BVOH was used as the binder, the durability was extremely excellent, and the color unevenness was extremely small.

On the other hand, in Comparative Example 1 in which the saponification degree of the PVA used as the binder was high, the microparticles were not appropriately dispersed, and color unevenness occurred. On the other hand, in Comparative Example 2 in which the saponification degree of the PVA used as the binder was low, the durability was poor.

As can be seen from the above results, the effects of the present invention are obvious.

The present invention is suitably applicable to a backlight of a LCD.

### EXPLANATION OF REFERENCES

10: planar lighting device
14: case
16: wavelength conversion film
18: light source
26: wavelength conversion layer
28: substrate
32: binder
34: microparticle
36: matrix
38: wavelength conversion particle

What is claimed is:

1. A wavelength conversion film comprising:
a wavelength conversion layer; and
a substrate that supports the wavelength conversion layer,
wherein the wavelength conversion layer includes a polyvinyl alcohol having a saponification degree in a range of 86 to 97 mol % and cured product particles of a (meth)acrylate compound including wavelength conversion particles.

2. The wavelength conversion film according to claim 1,
wherein the polyvinyl alcohol is a modified polyvinyl alcohol.

3. The wavelength conversion film according to claim 1,
wherein an average particle size of the cured product particles of the (meth)acrylate compound is 0.5 to 5 μm.

4. A wavelength conversion film comprising:
a wavelength conversion layer; and
a substrate that supports the wavelength conversion layer,
wherein the wavelength conversion layer includes a copolymer of butene diol and vinyl alcohol and cured product particles of a (meth)acrylate compound including wavelength conversion particles.

5. The wavelength conversion film according to claim 4,
wherein an average particle size of the cured product particles of the (meth)acrylate compound is 0.5 to 5 μm.

6. A method of manufacturing a wavelength conversion film comprising:
a step of preparing a dispersion in which wavelength conversion particles are dispersed in a liquid (meth)acrylate compound;
a step of preparing an emulsion by putting the dispersion into an aqueous solution of a water-soluble polymer;
a step of preparing a coating solution by irradiating the emulsion with light to cure the (meth)acrylate compound; and
a step of applying the coating solution to a substrate and drying the coating solution.

7. The method of manufacturing a wavelength conversion film according to claim 6,
wherein the water-soluble polymer is a polyvinyl alcohol having a saponification degree in a range of 86 to 97 mol %.

8. The method of manufacturing a wavelength conversion film according to claim 6,
wherein the water-soluble polymer is a copolymer of butene diol and vinyl alcohol.
